(19) United States
(12) Patent Application Publication
(10) Pub. No.: US 2006/0256244 A1
(43) Pub. Date: Nov. 16, 2006

(54) Display device and an illumination system therefor

(76) Inventors: Martin Jacobus Johan Jak, Eindhoven (NL); Hugo Johan Cornelissen, Eindhoven (NL); Hendrik De Koning, Eindhoven (NL); Dirk Jan Broer, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/547,807

(22) PCT Filed: Feb. 25, 2004
(86) PCT No.: PCT/IB04/50147

§ 371 Date: Sep. 1, 2005

(51) Int. Cl. G02F 1/133

(52) U.S. Cl. 349/33

(57) ABSTRACT

This invention relates to a display device (1), comprising a display panel (2) having a layer of electro-optical material (4), a first light-transmissive substrate (5) provided with electrodes (7) in an area of pixels arranged in rows and columns, a second light transmissive substrate (6), said layer of electro-optical material (4) being sandwiched between said first and second layer (5, 6), and an illumination system (3), being arranged on a side of the second substrate (6) being remote from said layer of electro-optical material (4), the illumination system comprising an optical waveguide (14) of an optically transparent material, having an exit face (15) facing said display panel (2). According to the invention, the illumination system (3) further comprises a matrix-addressable light-management member (27).

A display device and an illumination system therefor This invention relates to a display device comprising a light valve display panel and an illumination system. In particular this invention relates to a display device having an illumination system comprising an optical waveguide of an optically transparent material, having an exit face facing the display panel.

Displays utilising light valve or shutter technology are today commonly used. A typical example of such a display is a liquid crystal display. The basic function of light valve or shutter displays is that the display, or a pixel pattern thereof, may either transmit light (white pixel) or block light (black pixel), but the display may not generate light itself. Therefore, an illuminating backlight is needed. Such a backlight illuminates the liquid crystal display uniformly over its surface, and illuminates the display with a brightness such that the white pixels are perceived as sufficiently bright, after the light, emanating from the backlight, have passed through the low transmission liquid crystal display (the liquid crystal display has only a transmission of a few percent, typically between 5 and 10%, for example due to polarisers and colour filters arranged in the display). An example of such a display device is disclosed in the patent document WO 02/21042.

However, the above implies that the brightness of the white pixels of a liquid crystal display being illuminated by a backlight is independent of the image content, as opposed to prior art cathode ray tubes, in which the picture content affects the brightness of white pixels. This is due to the fact that, in a cathode ray tube, the average beam current is limited, and therefore white pixels become brighter if there are only a few of them. This phenomenon may give the displayed image a “sparkling” appearance.

Moreover, there are some fundamental differences between different display applications. When a display is used as a monitor, for example as a computer monitor, usually many pixels are in a relatively bright state, and thus the behaviour of liquid crystal displays are advantageous in such applications, i.e. the image stays bright, even if a lot of pixels are in a “white” state or in an on-state. However, for television applications the behaviour is differently. In typical television images usually only a small fraction of the pixels is very bright. In such situations, cathode ray tubes may obtain a brightness that cannot be matched by a liquid crystal display. In the backlight of the liquid crystal display, a large amount of light must first be generated, and since most of the screen is dark, most of the generated light will be absorbed again. This results in a waste of power and also limits the front of screen performance, which is considered to be a most important issue for liquid crystal television applications at the moment.

Moreover, the special properties of cathode ray tubes have been exploited further by a monitor feature referred to as LightFrame, being a trademark of Philips Monitors. By making a large part of the screen slightly darker, a small part, for example displaying a photo or a movie, may be boosted. It is desirable to obtain similar functionality for liquid crystal displays.

Hence an object of the present invention is to achieve a backlight for use in a liquid crystal display, having an improved peak brightness. Another object of the invention is to achieve a liquid crystal display having an improved black level, and yet an object of this invention is to achieve a liquid crystal display device, having an improved contrast. Yet an object of this invention is to improve the front of screen performance of liquid crystal displays in terms of contrast and colour range, and also to improve the efficiency of the backlighting.

The above and other objects are at least in part achieved by the invention as defined in claim 1. Hence, the invention teaches a display device, comprising a display panel having a layer of electro-optical material, a first light-transmissive substrate provided with electrodes in an area of pixels arranged in rows and columns, a second light-transmissive substrate, said layer of electro-optical material being sandwiched between said first and second layer, and an illumination system, being arranged on a side of the second substrate being remote from said layer of electro-optical material, the illumination system comprising an optical waveguide of an optically transparent material, having an exit face facing said display panel, being characterised in that said illumination system further comprises a matrix-addressable light-management member, such as for example a matrix-addressable out-coupling member. In this way, light generated by a light source may be distributed over the display panel in a more efficient way. Thereby, the contrast of the display may be improved, and local boosting and local dimming of the illumination device may be achieved. Suitably, said matrix-addressable light-management member comprises a liquid crystal material layer, a column electrode layer and a row electrode layer, the liquid crystal material layer being sandwiched between said column electrode layer and said row electrode layer, and said liquid crystal material layer is preferably constituted by a liquid crystal gel material. The term liquid crystal gel material is in this text to be construed as a material formed by photo-polymerisation of a liquid crystal and a poly-functional liquid crystal monomer in the presence of a photo-initiator which after polymerisation of the monomer switches from a transparent state to a highly scattering state upon the application of a voltage. The illumination system preferably further comprises a light source, being arranged at one of an edge of said matrix-addressable out-coupling member, on a back side of said matrix-addressable out-coupling member, as seen by an observer of said display device, or on a front side of said matrix-addressable out-coupling member, as seen by an observer of said display device.

Moreover, the display device suitably comprises a drive unit, being arranged to analyse bright and dark portions of an image to be displayed on said display panel and therefrom determine an illumination pattern to be displayed by said illumination device and simultaneously generate appropriate driving signals to the display panels to compensate for undesired transitions in luminance or colour caused by the illumination pattern. Suitably, said drive unit is arranged to feed addressing selection pulses to essentially consecutive addressing strips of an electrode of the illumination system, whereby the selection time of said selection pulses is longer than the frame time divided by the number of addressing strips, so that selection pulses of sequentially addressed strips will overlap. Thereby, the brightness of the illumination system may be improved. Alternatively, or complementary, said drive unit is arranged to simultaneously feed addressing selection pulses to two or more addressing strips of an electrode of the illumination system. This may be achieved by using different harmonics, or more generally orthogonal signals, for different strips (for example rows). Hence, it is possible to select multiple strips, in order to keep them on for a sufficiently long time, without scarifying the ability to set the brightness level for each pixel independently.

Suitably, the display device further comprises a bias level modulator being arranged to control the bias level of the illumination system. Thereby, local boosting of the luminance can be supplied, based on the video content for an image that is to be displayed.

Also, the display device may suitably comprise a light source power modulator for modulating the power of the light source of the illumination system, the modulation being dependant on an illumination pattern to be displayed by said illumination device. Hence, it is possible to further improve the contrast of the display, to improve the brightness and to achieve a better colour performance. Suitably, said light source to be modulated comprises one of cold cathode fluorescent lamps, hot cathode lamps, white light emitting diodes or a combination of coloured light emitting diodes.

The above and other objects are also at least in part achieved by a method of driving a display device as described above, the method comprising the steps of analysing an image that is to be displayed by the display panel with respect to bright and dark portions thereof, transforming the information regarding bright and dark portions of the analysed image to a resolution suiting said illumination device, transmitting information regarding the analysed image to the illumination device, transforming the information regarding the driving of the illumination device to a resolution suiting the display panel, to compensate for undesired transitions in luminance or colour caused by the illumination pattern and driving the illumination device by said transformed information.

The invention will hereinafter be described in closer detail, by means of presently preferred embodiments thereof with reference to the accompanying drawings.

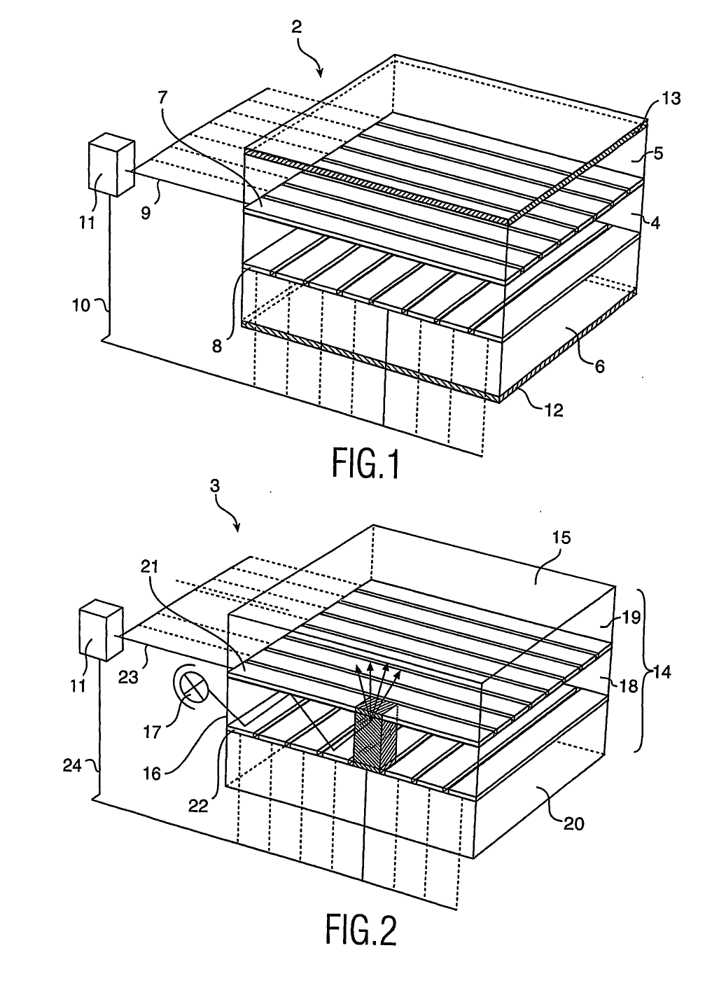

FIG. 1 is a schematic drawing of a display panel to be used with the present invention.

FIG. 2 is a schematic drawing of an illumination system according to this invention.

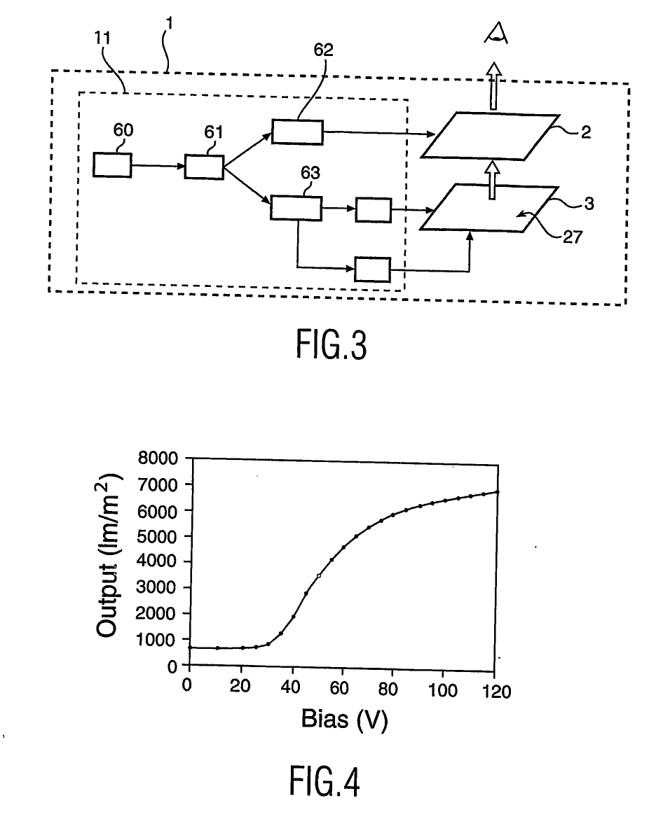

FIG. 3 is a schematic drawing of a display device according to the invention.

FIG. 4 is a diagram showing the electro-optical response for an examplatory illumination system.

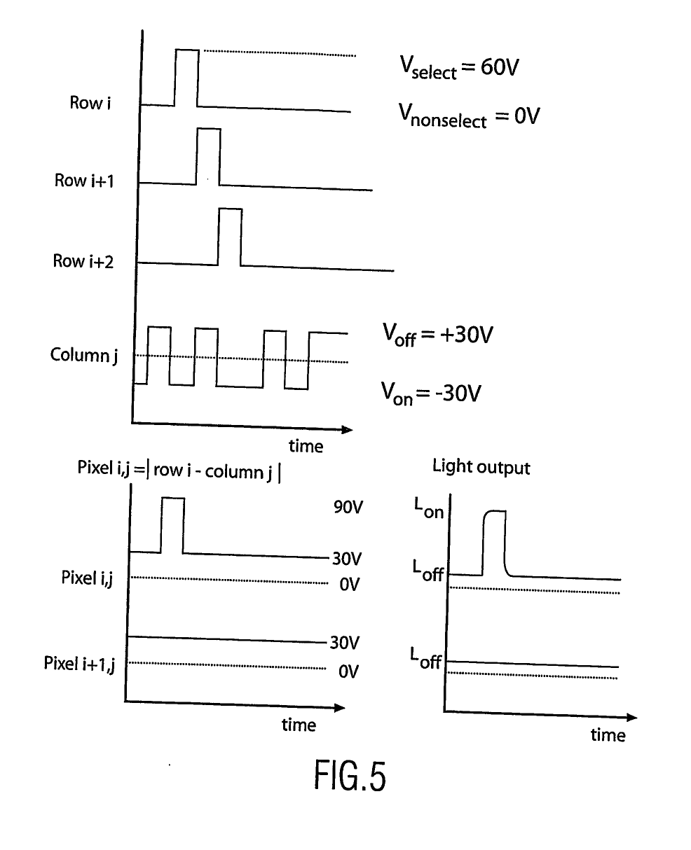

FIG. 5 discloses a set of diagrams representing passive matrix addressing of the illumination system.

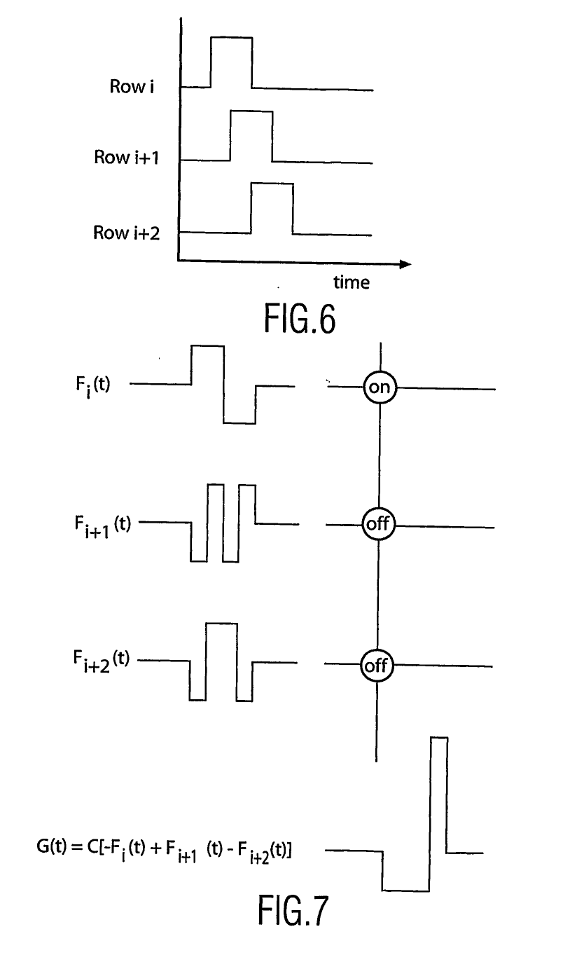

FIG. 6 discloses a modified addressing scheme for the illumination system according to the invention.

FIG. 7 discloses yet a modified addressing scheme for the illumination system according to the invention.

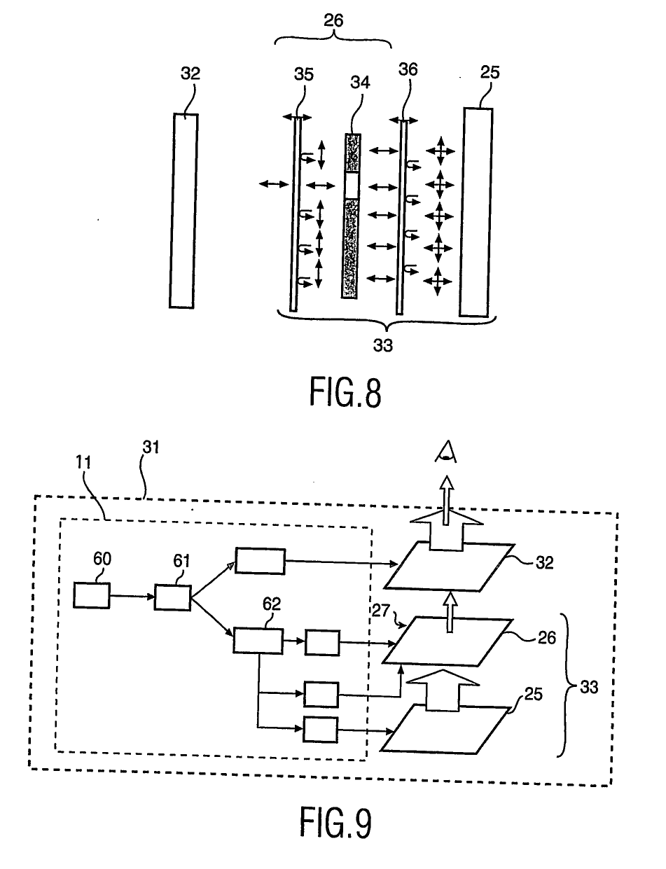

FIG. 8 discloses a schematic cross section of an alternative embodiment of the inventive display device

FIG. 9 is a schematic drawing of the display device according to FIG. 8.

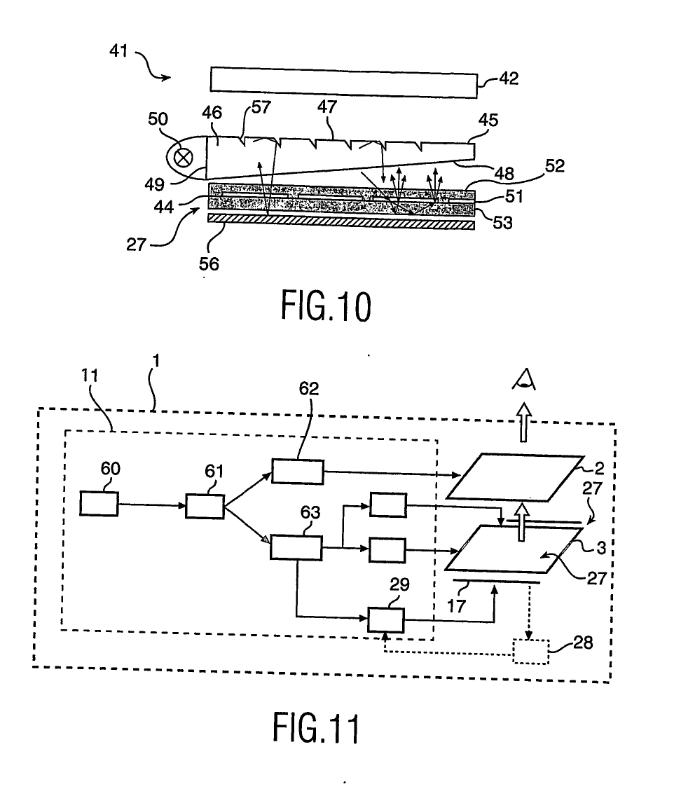

FIG. 10 is a schematic cross section of yet an alternative embodiment of the illumination system according to the invention.

FIG. 11 is a schematic drawing of a modified display device.

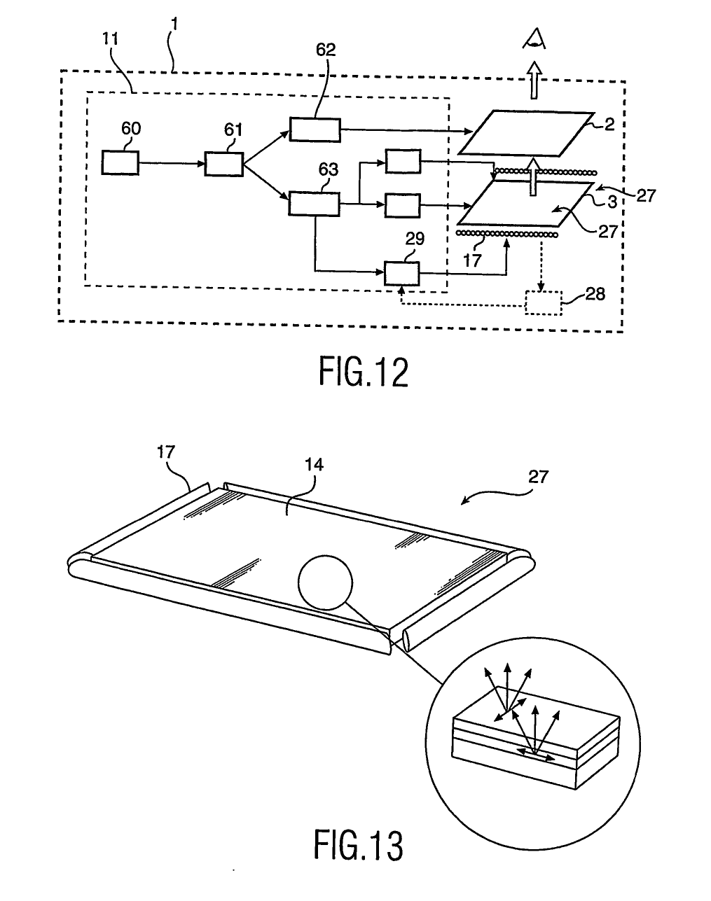

FIG. 12 is a schematic drawing of a modification of the display device disclosed in FIG. 11.

FIG. 13 is a schematic drawing of yet an embodiment of the illumination system.

A first preferred embodiment of this invention will hereinafter be described with reference to FIG. 1, FIG. 2 and FIG. 3.

A display device 1essentially comprises a display panel 2 and an illumination system 3.

The display panel 2, as shown in FIG. 1, essentially comprises a layer 4 of electro-optically active material, such as a liquid crystal material. In the case of a liquid crystal layer, the operation of the layer may be based on for example the twisted nematic (TN), the super-twisted nematic (STN), vertically aligned nematic (VAN), optically compensated birefringence (OCB), in-plane switching nematics (IPS) or the ferro-electric effect for modulating the polarisation direction of light incident thereon. The electro-optically hactive layer 4 is sandwiched between a first and a second substrate 5, 6. Moreover, the display panel is subdivided into a pixel pattern by means of a plurality of front and back electrodes 7 8, for example arranged in a matrix pixel fashion on said first substrate 5 and said second substrate 6, respectively, the electrodes being essentially transparent. Active matrix driving is preferably used in this case. The first substrate 5, as well as the second substrate 6 are of a light-transmissive material, and as stated above, the electrodes 7 are also light-transmissive and may for example be manufactured from indium tin oxide (ITO). The electrodes 7, 8 are connected, by means of connection wires 9, 10 to a drive unit 11 for providing an electrical drive voltage over said electrodes 7,8, the drive voltage being controlled by said drive unit 11. Moreover, the display panel commonly comprises a polariser 12 and an analyser 13 on per se known manner.

The illumination system 3 (see FIG. 2) to which this invention primarily relates, essentially comprises a waveguide structure 14 having an exit face 15, being arranged to face said display panel 2, and suitably four end faces 16. A light source 17, such as for example a rod shaped fluorescence lamp is arranged along at least one of said end faces 16, and light emitted by said light source is arranged to be coupled into the waveguide structure 14 through said end face 16. All surfaces of the waveguide structure 14, except the incoupling end face 16 and the exit face 15, may be provided with a reflective coating or the like, in order to prevent light from exiting the wave-guide at undesired positions.

According to this first embodiment of the invention, the waveguide structure 14 essentially comprises a layer 18 of a liquid crystal material, being sandwiched between a first waveguide substrate 19 and a second waveguide substrate 20. The liquid crystal material may be modulated between a transparent state and a scattering state by applying a voltage over the liquid crystal layer 18. Moreover, the waveguide is subdivided into a pixel pattern by means of a plurality of front and back waveguide electrodes 21, 22, arranged in a matrix pixel fashion on said first waveguide substrate 19 and said second waveguide substrate 20. Hence, the above structure constitutes a matrix-addressable light-management member and by addressing the electrodes 21 and 22 the pixel of the liquid crystal material layer 19 may be switched between a transmissive state, in which the pixel only transmits light which is later internally reflected within the waveguide 14, and a scattering state, in which light is scattered by the pixel and hence allowed to be transmitted through the exit face 15 of the waveguide 14, in direction towards the display panel 2. In the present example, the matrix-addressable light management member is an out-coupling member. However, the illumination device comprises several light-management members, such as out-coupling members, reflection, scattering and redirection members for which the present invention may be utilised. The resolution of the waveguide pixel pattern may preferably be larger or much larger than the corresponding pixel pattern of the display panel 2. The waveguide electrodes 21, 22 are connected, by means of connection wires 23, 24 to the drive unit 11 for providing an electrical drive voltage over said electrodes 21, 22, the drive voltage being controlled by said drive unit 11. Alternatively, a separate drive unit may be provided for driving the matrix waveguide. The waveguide electrodes 21, 22 are preferably in the form of strip electrodes, and may hence be referred to as column electrodes and row electrodes, respectively. By including both row and column electrodes in the waveguide structure and controlling the voltage applied over the electrodes, the amount of scattering of the scattering liquid crystal gel layer may be varied over the area of the illumination device surface, and the waveguide transports the light to the place where it is needed. Thus, by including such an illumination device in a display device, larger amounts of light may be emitted in the areas of the display device which is to display bright portions of the display screen, and smaller amounts of light (or no light) may be emitted in the areas of the display device which is to display dark portions of the display screen. Thereby, the maximum brightness and the black level (and thus the contrast ratio) of the display may be improved. Moreover, as compared to prior art liquid crystal displays, the power consumption may be reduced, since less light is to be absorbed by dark portions of the display.

The waveguide structure 14 as described above may for example be glued or by other means fastened to a thicker light guide, and as indicated above a reflector or a reflective coating may be arranged on a back side of the waveguide structure and a redirection foil may be arranged on a front side of the waveguide structure in order to further enhance the brightness of the backlight.

A suitable, preferred liquid crystal material that can be switched between a highly transparent state and a scattering state is a liquid crystal gel that is formed by photo-polymerisation of a blend of a non-reactive liquid crystal, which in itself may contain several components, a liquid crystalline monomer and a photo-initiator. Before photo-polymerisation the blend is aligned at a surface alignment layer and the blends is transparent. After photo-polymerisation, by exposure with UV light, a polymer network micro-phase separates where the polymer network molecules have the same alignment and preferably the same optical properties, i.e. about equal ordinary and extraordinary refractive indices. This so-called liquid crystal gel is still transparent. Only after the application of an electrical field, the non-reacted liquid crystal respond to the electrical field by adapting another average orientation than the network molecules. The resulting refractive index transitions result in a scattering of the material, helped by the formation of multi-domains in the non-reacted liquid crystal area enhanced by the presence of the network. The zero-voltage alignment can be planar parallel to the propagating wave in the waveguide, planar perpendicular to that or perpendicular to the surface of the electrodes. In the latter case a special liquid crystal mixture must be selected with a net negative dielectric anisotropy such that the molecules align perpendicular to the electrical field lines. In another embodiment of the invention the scattering liquid crystal consists of a so-called polymer dispersed liquid crystal (PDLC). PDLC systems are well known in the field and are characterized by the fact that they show scattering in the field-off state and becomes transparent upon the application of an electrical field. The advantage of LC gels as described and a PDLC system is that the transparent state is clearer, i.e. show less scattering and therefore a much higher transmission for the wave guiding rays. A second advantage of the LC gel as described is that it responds much faster to the electrical field and switching speeds of the order of milliseconds are very well p[possible whereas PDLC systems typically switch with rates of ten of milliseconds.

The driving of the display device disclosed above will hereinafter be described in closer detail. The driving arrangement is schematically shown in FIG. 3.

First an image that is to be displayed on the display panel 2 is provided by an image content provider 60. The image content is transmitted to an image analysis device 61, which the image content is analysed in order to find which parts of the image are bright and which parts are dark. With this information the illumination system 3 as well as the display panel 2 may be controlled. Hence, the analysed image content is transmitted to a display panel control unit 62, arranged to control the signal application to the display panel electrodes 7,8. The analysed image content is also transmitted to an illumination system control unit 63, in which the image content is processed and potentially transformed to the illumination system pixel format, and thereafter transmitted to the corresponding electrodes 21, 22 of the illumination system 3 in order to control the scattering thereof. However, changing the backlight intensity of the illumination system in one area with respect to another area also means that the grey values of the image being shown on the display panel 2 may need to be modified, which may be achieved by the display panel control unit 62.

The illumination device 3 may combine highlighting according to this invention with the functionality of a scanning backlight, as for example disclosed in WO 02/21042. This may be achieved for example if the rows light up one at a time. Since the liquid crystal gel material responds much faster than ordinary LC materials row scanning may be achieved with standard passive matrix addressing. Instead of responding to the Root Mean Square (RMS) value of the signal, a row will be ‘on’ during its addressing time only. Since the rows are addressed sequentially, the rows will light up one at a time.

The driving arrangement is linked to the material properties and the processing details of the scattering liquid crystal gel material and is described in more detail below. A typical electro-optical response curve of the illumination device or backlight is shown in FIG. 4. The liquid crystal gel material responds to the absolute value of a voltage difference between the column and row potentials as applied by the drive unit 11. The liquid crystal gel material has a response time in the order of 1 ms. As can be seen in FIG. 4, there is a certain threshold voltage below which the material is basically transparent, and the light output of the illumination device 3 is low. This threshold can be used for selecting rows, as is also done in normal passive matrix addressing. In this case a row selection voltage of 60 V may be used, while the column signal can range from −30 V to +30 V (−30 being the on state, +30 the off state). If a row is not selected, the pixel bias is 30V maximum, while a selected row may vary from 30 to 90V. This driving method is shown schematically in FIG. 5.

There is one major difference with ordinary passive matrix driving as used in the prior art, and the passive matrix driving used in this invention, namely the speed of response of the liquid crystal gel of the scattering layer 18. Ordinary passive matrix driving works with slow liquid crystal materials that respond to an RMS value of the bias voltage, averaged over a relatively long time (more than 1 frame). In that case a very steep voltage transmission curve is needed in order to be able to drive a significant number of rows. However, the liquid crystal gel material used in the illumination device according to this invention is very fast and responds nearly instantaneously. Therefore it gives short pulses, and the number of rows is not limited by the V-T curve.

A typical LC gel material, as may be used in the layer according to the present invention, is constituted by the following components:

1. A liquid crystal blend. For this a commercial LC blend may be selected, preferably one with a net negative dielectric anisotropy and a large birefringence to enhance scattering. An example is a liquid crystal blend that is commercialised by Merck is BL109.
2. A liquid crystalline monomer. Suitable such materials are described in D. J Broer et al., Makromol. Chem. 190, 3201-3215 (1989) and D. J Broer, Photoinitiated polymerization and crosslinking of liquid-crystalline systems. Radiation Curing Polym. Sci. Technol (ed. Fouassier, Jean-Pierre; Rabek, J.)-Vol3., 383-443 (1993). In a preferred embodiment use is made of a liquid crystalline diacrlylate with the following chemical structure: 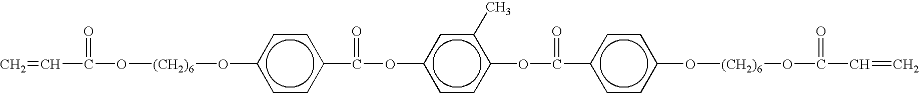
A preferred concentration is between 6 and 12 Wt %.
3. A photoinitiator. A typical photoinitiator is commercially available under the tradename Irgacure 651 (Ciba Geigy). The amount is normally around 1 wt % calculated on the amount of reactive monomer.

Further, the film thickness, (i.e. the cell gap) of this layer is typically between 6 to 18 micrometer. The switching voltage somewhere between 60 and 120 Volts, depending on the cell gap.

However, in order to obtain sufficient light output from the illumination device, it may be required to make the light emitting period sufficiently long. Since this implies that the row selection time should be sufficiently long, only a limited number of rows can be selected in one frame time. Hence, this may still limit the resolution of the illumination device, but in a different way than in ordinary passive matrix panels as in the prior art.

A modified addressing scheme for the display device disclosed above will hereinafter be described. The light output from the illumination device 3 may be increased by increasing the row selection time. Instead of decreasing the resolution of the matrix structure, this may be achieved by overlapping the selection pulses for consecutive rows, see FIG. 6. However, this has some consequences. Since more than one row is selected at a certain moment in time it is no longer possible to give every pixel any desired value. If the same column or data driving is used as described above the light pattern shown on the illumination device or backlight will be smeared along the columns. The amount of smearing depends on the number of rows that is selected simultaneously. However, since this only affects the illumination device, and not the entire display device, this may be acceptable considering the brightness gain. Furthermore the smearing along the columns can be counteracted to some extent by pre-processing the illumination device illumination pattern for example by means of high pass filtering along the columns.

Ideally, one would like to select multiple rows in order to keep them on for a sufficiently long time, without sacrificing the ability to set the brightness level for each pixel independently. This may be achieved by using different harmonics, or more general orthogonal signals, for different rows, as is known in multiple row addressing of prior art, ordinary liquid crystal display panels. This method is illustrated in FIG. 7. The column signal is a superposition of the different orthogonal functions. The sign determines whether a pixel is on or off. For this method to work, the frequency of the harmonics should be so high that the liquid crystal gel only may respond to the root mean square value of the drive voltage. In other words, the liquid crystal gel should be slow with respect to the frequency of the multiple row addressing functions, and at the same time be fast enough so that it can be switched on and off within a frame time. The maximum number of rows that may be multiplexed in this way depends on the steepness of the electro-optical response (FIG. 4) and the desired contrast (maximum voltage for the on state decreases when more rows are multiplexed). With the example T-V curve of FIG. 4, where V_ON=60V and V_OFF=30V, the maximum number of rows that can be simultaneously addressed with maximum contrast equals 3.

A second preferred embodiment of this invention will hereinafter be described with reference to FIG. 8, and FIG. 9.

This display device 31 essentially comprises a display panel 32 and an illumination system 33.

The display panel 32 is essentially identical with the one described in the above embodiment and will therefore not be closer described here.

The illumination system 33 essentially comprises a backlight 25 and a backlight modulator 26. The backlight 25 may be of a standard type, generating a constant bias light level. The backlight modulator 26 is arranged between the backlight 25 and the display panel 32. In this case, the backlight modulator 26 may essentially comprise an electro-optically active layer 34 (see FIG. 8), such as a liquid crystal layer, being addressed by means of front and back electrodes, as is closer described above. The electro-optically active layer with corresponding addressing means is sandwiched between a first and a second reflecting polariser 35, 36. The above structure constitutes a matrix-addressable light management member. Hence, the electro-optically active layer 34 of the backlight modulator 26 is arranged to modulate the light emitted from a standard type backlight 25, while the reflective polarisers 35, 36 are used to recycle light that have an unwanted polarization or being emitted at a “dark” portion of a picture that is to be displayed by the display device, as is illustrated in FIG. 8. In this way, the efficiency of the backlight may be boosted. The driving of this type of display device is schematically shown in FIG. 9. Here, an image is to be displayed on the display device. Information regarding the image to be displayed (i.e. the image content) is for example received by means of a video signal or the like from an image content provider 60. The image content is thereafter transmitted to an image analysis device 61, for analysing the image content with respect to brighter and/or darker portions thereof. This image analyse information is thereafter used to form a processed image signal, which is transmitted to the display panel 2, and is arranged to control the image display of the display panel 2. Moreover, the image analysis information is used to form a 2D backlight information signal in an illumination system control unit 62, being arranged to control the transmission of the backlight modulator, in accordance with the information regarding brighter and/or darker portions of the image to be displayed. Moreover, the 2D backlight information signal is transmitted to a bias level modulator 64 used to modulate a bias level signal, arranged to control the bias level of the standard type backlight 25.

An alternative embodiment is disclosed in FIG. 10. Here, the display device 41 essentially comprises a display panel 42 and an illumination system 43.

The display panel 42 is essentially identical with the one described in the above embodiment and will therefore not be closer described here.

The illumination system 43 essentially comprises an essentially standard-type backlight 45 for bias level luminance and a scattering modulator panel 44, being essentially separated from the backlight 45. The backlight 45 is essentially sandwiched between the liquid crystal panel 42 and the modulator panel 44.

The backlight 45, essentially comprises a waveguide structure 46 having a first exit face 47, being arranged to face said display panel 42, a second exit face 48, being arranged to face the modulator panel 44, and suitably four end faces 49. A light source 50, such as for example a rod shaped fluorescence lamp is arranged along at least one of said end faces 49, and light emitted by said light source is arranged to be coupled into the waveguide structure 46 through said end face 49 All surfaces of the waveguide structure 46, except the incoupling end face 49 and the exit faces 47, 48, may be provided with a reflective coating or the like, in order to prevent light from exiting the wave-guide at undesired positions. The waveguide structure 46 may have a tapered shape, and may also be provided with reflection controlling grooves 57 or the like, in order to obtain a suitable reflection pattern for the waveguide.

The scattering modulator panel 44, constituting the matrix-addressable light-management member, essentially comprises a layer 51 of liquid crystal gel material, being sandwiched between a first substrate 52 and a second substrate 53. Moreover, the scattering modulator panel 44 is subdivided into a pixel pattern by means of a plurality of front and back electrodes (not shown), such as strip electrodes, arranged in a matrix pixel fashion on said first substrate 52 and said second substrate 53. As above, the resolution of the scattering modulator panel pixel pattern may be lower or much lower than the corresponding resolution of the display panel 42. Furthermore, the illumination system is provided with a reflecting mirror 56, being arranged so that the modulator panel 44 is sandwiched between the reflecting mirror 56 and the backlight 45.

The function of this embodiment will hereinafter be described. Light is emitted from the light source 50, and entered into the waveguide structure 46 through the transmissive end face 49. Within the waveguide structure 46, the light is internally reflected by the tapered structure and the reflection controlling grooves 57 so that light essentially is emitted through only the second exit face 48 facing the modulator panel 44. The modulator panel 44 is controlled as described above, so that some pixels are in a transparent mode and some pixels are in a scattering mode, depending on the image to be displayed by the display panel 42. Hence, light falling into a transparent pixel will be transmitted through it and be reflected by the reflecting mirror 56 and back into the waveguide structure. On the other hand, light falling onto a scattering pixel will be scattered in the direction of the waveguide structure without being reflected by the mirror 56.

Hence, according to this embodiment, the modulator is not arranged inside the waveguide, as in the embodiments described above. Consequently, absorption losses associated with layers of for example ITO or other thin layers are prevented. However, the ON/OFF luminance ratio will be less than in the initially described embodiment of this invention.

A further advantageous alteration of this invention will hereinafter be described with reference to FIG. 11, FIG. 12 and FIG. 13. The aim of this alteration is to improve the front of screen performance of the liquid crystal display panels described above in terms of contrast and colour range, and to improve the efficiency of backlighting. For this purpose, it is proposed to modulate the power of the light source of the illumination system synchronised with the scrolling scattering stripe of the scanning or highlighting backlight. In this way the bright parts of the backlight may be made brighter and the dark parts darker. Since the light is more efficiently transported to the place where it is needed this will result in more efficient backlighting and a brighter sparkling image. By applying the same technique separately for different colours, such as red, green and blue light sources, the colour of the backlight may be varied over the screen. Effectively this results in a larger range of usable colours.

The embodiment of FIG. 11 essentially corresponds to the embodiment disclosed in FIG. 3, and the basic functions of the display will therefore not be repeated here. However, according to this embodiment, the display further comprises a lamp driver/light source power modulator 29. In order to modulate the power of the lamps of the backlight 3 by means of the lamp driver 29, the required signals will need to be generated. The image to be displayed by the display panel is analysed and from that the intensity levels of the backlight are derived. The intensity levels may thereafter be split by the illumination system control unit 63 in a modulation signal for modulating the scattering power of the LC-gel in the backlight and a modulation of the light source power. In order to be sufficiently accurate it may be desired to include a feedback loop comprising one or more light sensors 28 that measures the actual lamp output and compares this with the required output. The process is schematically shown in FIG. 11. The detected signal of the light sensor 28 is arranged to be fed back to the lamp driver 29, the lamp driver also being connected to receive information from the illumination system control unit 63. Thereby, the power fed to the pixel may be varied in response to the image content to be display by the pixel. Hence, by varying the light source power while the segmented backlight is being addressed, the contrast of the display may be improved. When a segment i is being addressed (i.e. it is scattering) the power source will have power pi, and when a segment j is scattering the source will have power pj. The power pi is adjusted depending on the required brightness for segment i and the average power of the lamp of the backlight 3 should be constant. By this embodiment, a display device having an improved contrast, and improved peak brightness and better colour performance may be achieved.

Preferably, the light sources of the backlight is constituted by light emitting devices (LEDs) and such devices may be varied in power relatively easily in an efficient way. Moreover, LEDs may be switched very fast and are limited by the average power, and hence short pulses may be made very bright.. Alternatively, the light sources of the backlight may be constituted by cold cathode fluorescent lamps (CCFL) having different phosphors or phosphor mixes.

Moreover, the use of LEDs are advantageous in that LEDs are commercially avalailable for different wavelengths, and are hence especially suitable for combining both power and colour modulation. Hence the inventive concept may be extended to varying for example R,G,B light sources of a colour display independently. This is indicated by FIG. 12 In this way both the power and the colour of the light is varied. Although this does not (or hardly) increase the size of the colour triangle, it does result in a shift of the colour triangle. This shift can be set independently for every segment that is addressed. Although within one segment only a ‘normal’ colour triangle is available, the colour range for the entire screen increases.

In combination with time-sequentially adaptation of the colour gamut also additional enhancements are possible. For instance when an image is analysed to need locally a higher brightness whereas at the remaining area the colour gamut is more important, an extra boost to the brightness can be provided by filling the colour filter bandwidth by simultaneously switching-on all the light sources emitting in this colour region. In yet another embodiment (see FIG. 13), the modulated outcoupling of light of the scanning backlight operates on the principle of electrically addressed refractive indices that discriminate between total reflection (no outcoupling) and transmission at an interface. The refractive index modulation can be made directionally dependent. This means by stacking two index switching layers the first layer will modulate R,G,B coming from one direction whereas the second layer will modulate the slightly shifted R′, G′, B′ colours coming from the orthogonal direction (see FIG. 13).This has the advantage that both sets of light sources, R,G,B and R′,G′,B′, may be switched on continuously. This might be beneficial if two sets of fluorescent lamps are used rather that the fast switching LEDs. It should also be possible to make the scattering elements directionally dependent.

The protective scope of the invention is not limited to the embodiments shown. The invention resides in each and every novel characteristic and each and every combination of characteristic features. Moreover, reference numerals in the claims are not to be construed as limiting their protective scope.

It shall be noted that the above-described inventive concept may be used for different types of electro-optically active display panels, such as liquid crystal display panels, or other types of light valve or shutter systems. Moreover, it shall be noted that the invention is not limited to monochrome and RGB displays but may in fact be utilised to any display, independent of its colours.

1. A display device, comprising
a display panel having a layer of electro-optical material, a first light-transmissive substrate provided with electrodes in an area of pixels arranged in rows and columns, a second light-transmissive substrate, said layer of electro-optical material being sandwiched between said first and second substrate , and
an illumination system, being arranged on a side of the second substrate being remote from said layer of electro-optical material, the illumination system comprising an optical waveguide of an optically transparent material, having an exit face facing said display panel, characterised in that said illumination system further comprises a matrix-addressable light management member.

2. A display device as in claim 1, wherein said matrix-addressable light management member is an out-coupling member comprising a liquid crystal material layer, a column electrode layer (21) and a row electrode layer, the liquid crystal material layer being sandwiched between said column electrode layer and said row electrode layer.

3. A display device as in claim 2, wherein said liquid crystal material layer is constituted by a liquid crystal gel material.

4. A display device as in claim 1, wherein the illumination system further comprises a light source, being arranged at at least one of an edge of said matrix-addressable out-coupling member, on a back side of said matrix-addressable out-coupling member, as seen by an observer of said display device, or on a front side of said matrix-addressable out-coupling member, as seen by an observer of said display device.

5. A display device as in claim 1, further comprising a drive unit, being arranged to analyse bright and dark portions of an image to be displayed on said display panel and therefrom determine an illumination pattern to be displayed by said illumination device and essentially simultaneously generate an appropriate driving signal to said display panel in order to compensate for undesired transitions in luminance or colour caused by the illumination pattern.

6. A display device as in claim 5, wherein said drive unit is arranged to feed addressing selection pulses to essentially consecutive addressing strips of an electrode of the illumination system, whereby the selection time of said selection pulses is longer than the frame time divided by the number of addressing strips, so that selection pulses of sequentially addressed strips will overlap.

7. A display device as in claim 5, wherein said drive unit is arranged to simultaneously feed addressing selection pulses to two or more addressing strips of an electrode of the illumination system.

8. A display device as in claim 1, further comprising a bias level modulator being arranged to control the bias level of the illumination system.

9. A display device as in claim 1, further comprising a light source power modulator for modulating the power of the light source of the illumination system the modulation being dependant on an illumination pattern to be displayed by said illumination device.

10. A display device as in claim 9, wherein said light source to be modulated comprises one of cold cathode fluorescent lamps, hot cathode fluorescent lamps, white light emitting diodes or a combination of coloured light emitting diodes.

11. An illumination system as described in claim 1 for use in a display device as described in claim 1.

12. A method of driving a display device as claimed in claim 1, comprising the steps of:
analysing an image that is to be displayed by the display panel with respect to bright and dark portions thereof,
transforming the information regarding bright and dark portions of the analysed image to a resolution suiting said illumination device,
transmitting information regarding the analysed image to the illumination device,
transforming the information regarding the driving of said illumination device to a resolution adapted for said display panel, in order to compensate for undesired transitions in one of luminance and colour caused by the illumination pattern, and
driving the illumination device by said transformed information.
